(19) United States
(12) Patent Application Publication
(10) Pub. No.: US 2026/0059569 A1
(43) Pub. Date: Feb. 26, 2026

(54) PRIMARY CHANNEL INDICATION FOR NON-PRIMARY CHANNEL ACCESS (NPCA) COMMUNICATIONS

(71) Applicant: QUALCOMM Incorporated, San Diego, CA (US)

(72) Inventors: Gaurang NAIK, San Diego, CA (US); Abhishek Pramod PATIL, San Diego, CA (US); Alfred ASTERJADHI, San Diego, CA (US); George CHERIAN, San Diego, CA (US); Sai Yiu Duncan HO, San Diego, CA (US); Sherief HELWA, San Diego, CA (US); Giovanni CHISCI, San Diego, CA (US); Sanket Sanjay KALAMKAR, San Diego, CA (US)

(21) Appl. No.: 18/814,262

(22) Filed: Aug. 23, 2024

(51) Int. Cl. H04W 74/0816; H04W 74/08

(52) U.S. Cl. CPC H04W 74/0816; H04W 74/0866

(57) ABSTRACT

Certain aspects of the present disclosure are directed towards a wireless communication device. The wireless communication device generally includes a processing system that includes one or more processors and one or more memories coupled with the one or more processors, the processing system configured to cause the wireless communication device to: obtain a first frame transmission via a first primary channel or a second primary channel, wherein the first frame transmission includes an indication of whether the first frame transmission is via the first primary channel or the second primary channel; and cause a second frame transmission in response to obtaining the first frame transmission, wherein the second frame transmission is via the first primary channel or the second primary channel based on the indication.

### TECHNICAL FIELD

This disclosure relates generally to wireless communication, and more specifically, to techniques related to primary channel access for non-primary channel access (NPCA) communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

Certain aspects of the present disclosure are directed towards a wireless communication device. The wireless communication device generally includes a processing system that includes one or more processors and one or more memories coupled with the one or more processors, the processing system configured to cause the wireless communication device to: obtain a first frame transmission via a first primary channel or a second primary channel, wherein the first frame transmission includes an indication of whether the first frame transmission is via the first primary channel or the second primary channel; and cause a second frame transmission in response to obtaining the first frame transmission, wherein the second frame transmission is via the first primary channel or the second primary channel based on the indication.

Certain aspects of the present disclosure are directed towards a wireless communication device. The wireless communication device generally includes a processing system that includes one or more processors and one or more memories coupled with the one or more processors, the processing system configured to cause the wireless communication device to: cause a first frame transmission via a first primary channel or a second primary channel, wherein the first frame transmission includes an indication of whether the first frame transmission is via the first primary channel or the second primary channel; and obtain a second frame transmission in response to the first frame transmission, wherein the second frame transmission is via the first primary channel or the second primary channel based on the indication.

Certain aspects of the present disclosure are directed towards a method for wireless communication by a wireless communication device. The method generally includes: obtaining a first frame transmission via a first primary channel or a second primary channel, wherein the first frame transmission includes an indication of whether the first frame transmission is via the first primary channel or the second primary channel; and causing a second frame transmission in response to obtaining the first frame transmission, wherein the second frame transmission is via the first primary channel or the second primary channel based on the indication.

Certain aspects of the present disclosure are directed towards a method for wireless communication by a wireless communication device. The method generally includes: causing a first frame transmission via a first primary channel or a second primary channel, wherein the first frame transmission includes an indication of whether the first frame transmission is via the first primary channel or the second primary channel; and obtaining a second frame transmission in response to the first frame transmission, wherein the second frame transmission is via the first primary channel or the second primary channel based on the indication.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a pictorial diagram of an example bandwidth configuration for a wireless local area network (WLAN).

FIGS. 6A and 6B show examples of transmitter and receiver radio resources assignment.

FIG. 7 shows example bandwidth signaling.

FIG. 8 shows an example of OBSS transmit opportunity (TXOP).

FIG. 9 illustrates ready to send (RTS) and clear to send (CTS) communications between an access point (AP) and a non-AP station (STA).

FIG. 10 illustrates a trigger frame and response communications between an AP and a non-AP STA.

FIGS. 11 and 12 illustrate trigger frame and response communications with a channel indication, in accordance with certain aspects of the present disclosure.

FIGS. 13 and 14 illustrate RTS and CTS communications using a channel indication, in accordance with certain aspects of the present disclosure.

FIG. 15 illustrates a service field in which a channel indication may be included, in accordance with certain aspects of the present disclosure.

FIG. 16 illustrates a high-efficiency (HE) variant Common Information field in which a channel indication may be included, in accordance with certain aspects of the present disclosure.

FIG. 17 illustrates an extremely high throughput (EHT) variant Common Info field in which a channel indication may be included, in accordance with certain aspects of the present disclosure.

FIG. 18 illustrates a Special User information field of a Trigger frame in which a channel indication may be included, in accordance with certain aspects of the present disclosure.

FIGS. 19A and 19B illustrate User Information fields, in which a channel indication may be included, in accordance with certain aspects of the present disclosure.

FIG. 20 shows a flowchart illustrating an example process performable by or at a wireless communication device that supports wireless communication

FIG. 21 shows a flowchart illustrating an example process performable by or at a wireless communication device that supports wireless communication

FIG. 22 shows a block diagram of an example wireless communication device that supports wireless communication

FIG. 23 shows a block diagram of an example wireless communication device that supports wireless communication Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

An NPCA STA may contend for access to, and transmit on, the O-Primary channel if certain conditions are met. For example, an NPCA STA may contend and transmit on the O-Primary channel if a main primary channel (M-Primary channel) (e.g., which may also be referred to as a primary channel, a primary 20 MHz channel, an NPCA primary, an anchor primary, a temporary primary, and/or a backup primary) is occupied by OBSS traffic, and is, therefore, busy, and if the OBSS traffic occupying the M-Primary channel does not overlap with O-Primary channel. In some cases, a transmitter may detect OBSS traffic on the M-Primary channel and begin contending on the O-Primary channel, whereas the transmitter may not detect the OBSS traffic and continue contending on the M-Primary channel, causing a miscoordination as described in more detail herein. In some cases, a transmitter may expect a response to a frame transmission from a receiver to be via the M-Primary channel. However, due to this miscoordination, the response from the receiver may respond via the O-Primary channel, which may cause the response frame from the receiver to collide with and, therefore, degrade performance of the responder's and/or other transmissions.

Some aspects described herein may relate to primary channel indication for NPCA communications. In particular, in some aspects, the frame transmission may include a channel indication of the primary channel via which the frame was transmitted. The channel indication may indicate whether a transmitter performed a successful contention-based channel access on a first primary channel or a second primary channel to perform the frame transmission. Using the channel indication, the receiver may determine how to (or whether to) respond to the frame transmission. For example, a trigger frame or an RTS frame may be transmitted with one or more bits indicating whether the frame was transmitted via an M-Primary channel or an O-Primary channel. In some cases, the channel indication may be implied by the format of the frame or a bandwidth (BW) indication in the frame. Using the channel indication, a receiver may determine whether to generate a response to the frame via the M-Primary channel (e.g., a bandwidth that covers the M-Primary channel) or via the O-Primary channel (e.g., a bandwidth that covers the O-Primary channel but does not cover the O-Primary channel.

Particular aspects of the subject matter described in this disclosure can be implemented to realize one or more of the following potential advantages. In some examples, by indicating the primary channel via which the frame transmission is performed, the described techniques can be used to improve communication reliability and efficiency. The channel indication may reduce or eliminate the effect of miscoordination between a transmitter and receiver (e.g., miscoordination due to detection of an OBSS by the transmitter or receiver as described). Scenarios where a receiver responds using a different channel than expected by the transmitter may be avoided or at least reduced.

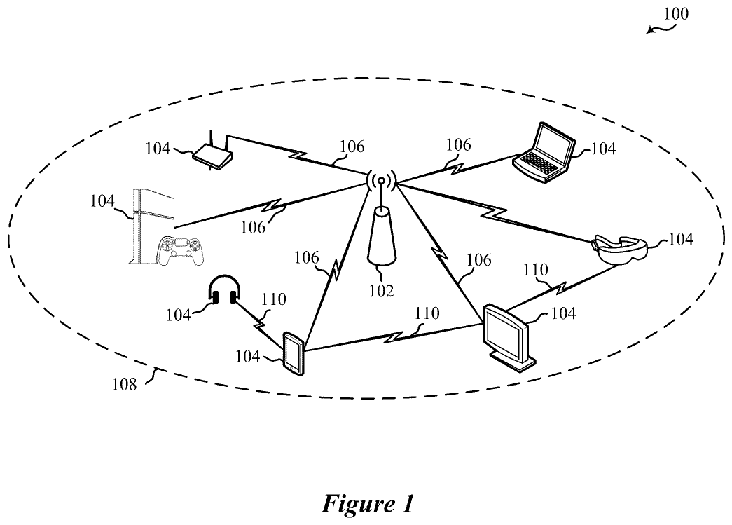

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz - 7.125 GHz), FR2 (24.25 GHz - 52.6 GHz), FR3 (7.125 GHz - 24.25 GHz), FR4a or FR4-1 (52.6 GHz - 71 GHz), FR4 (52.6 GHz - 114.25 GHz), and FR5 (114.25 GHz - 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel (e.g., which may also be referred to as a primary channel, a primary 20 MHz channel, an NPCA primary, an anchor primary, a temporary primary, and/or a backup primary) and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log signal to noise ratio (SNR) trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80 +80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by channel state information (CSI) feedback compression, etc.), enhancing roaming or other mobility operations, multi-AP coordination, and generally facilitating network management or optimizing network connections or characteristics to, for example, increase throughput or capacity, reduce latency or otherwise enhance user experience.

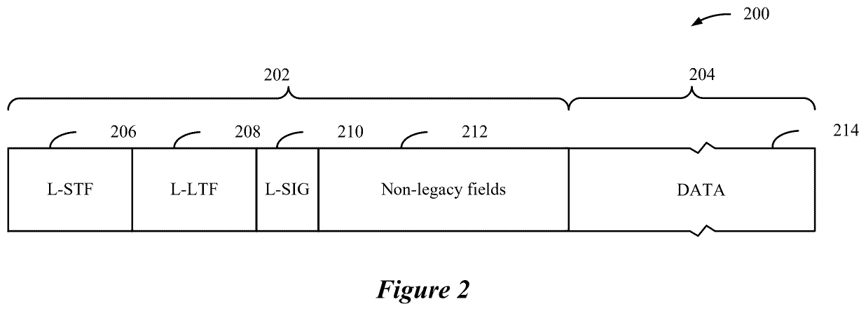

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

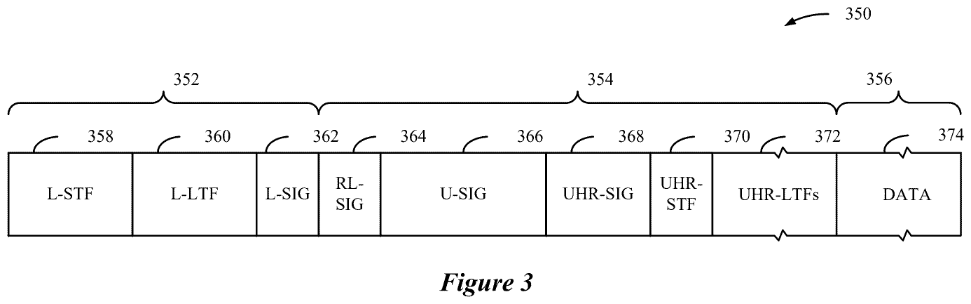

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is an UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different SNRs), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

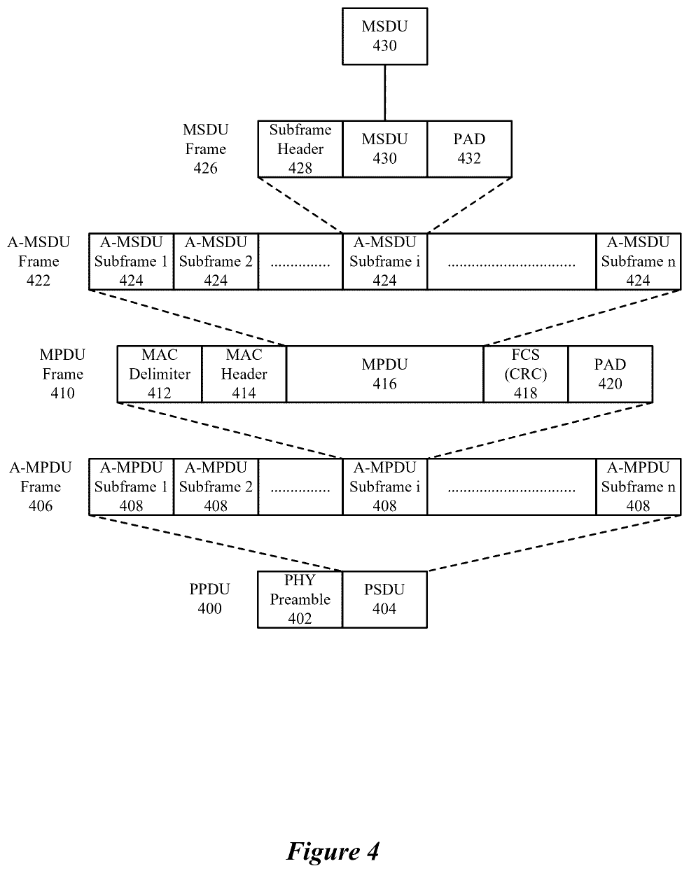

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of the wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each access category (AC) may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

### Overview of Npca

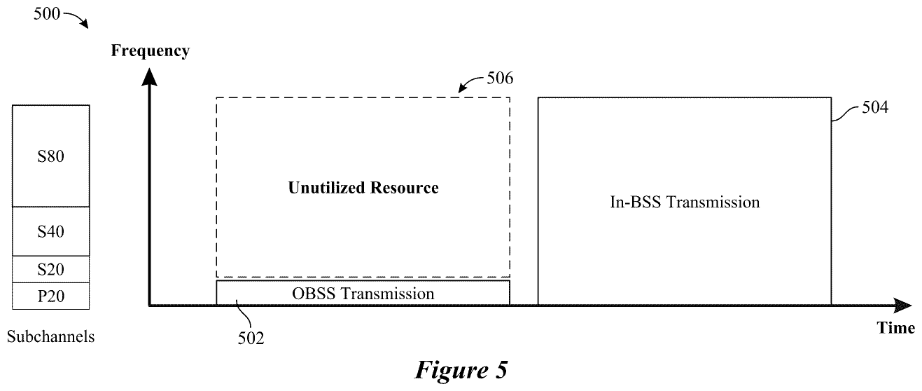

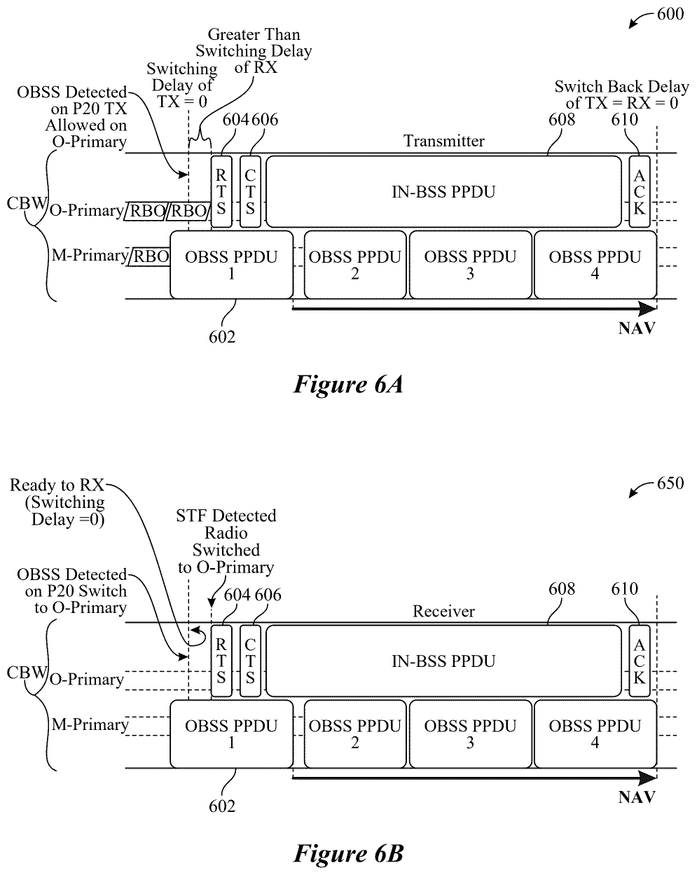

FIG. 5 shows a pictorial diagram of an example bandwidth configuration 500 for a wireless local area network (WLAN). A primary channel generally refers to a channel that a STA monitors for contention-based channel access. As shown in FIG. 5, WLANs that support relatively large bandwidths, one 20 MHz channel may be designated as a primary channel. This channel may be referred to as primary 20 (P20) (also referred to herein as an “M-Primary channel”). Selection of the bandwidth for the M-Primary channel typically controls selection or allocation of all other channels. For example, in the case of a 160 MHz operating bandwidth, selection of M-Primary channel may control allocation of a secondary 20 MHz channel (S20), a primary 40 MHz channel (P40), a secondary 40 MHz channel (S40), a primary 80 MHz channel (P80), and a secondary 80 MHz channel (S80). In some cases, if an OBSS transmission 502 is detected on the M-Primary channel, the remaining portion 506 of the BSS BW may be utilized until a following transmission opportunity where an in-BSS transmission 504 may be performed. Some implementations are directed towards increasing spectrum utilization as described in more detail with respect to FIGS. 6A and 6B.

FIG. 6A shows a diagram 600 illustrating an example non-primary channel access (NPCA) STA in a scenario in which transmission is allowed on a non-primary channel (opportunistic primary channel O-P20, also referred to herein as “O-Primary channel”).

In the illustrated example, while contending for channel access on a first (main) primary channel to send a PPDU, the STA detects an OBSS transmission (e.g., OBSS PPDU 602) on the M-Primary channel (during countdown of a random backoff (RBO) counter). In response, since transmission is allowed on the O-Primary channel, the STA switches to the O-Primary channel. After contending for (and gaining) access on the O-Primary channel, the STA sends an initial control frame (such as request to send (RTS) 604 or a buffer status report poll (BSRP) trigger frame) and, after receiving the response to the initial control frame (such as a clear to send (CTS) 606 or a buffer status report frame), transmits a (In-BSS) PPDU 608. As illustrated, the intended recipient may send an acknowledgment (ACK) 610 of receipt of the PPDU.

FIG. 6B shows a diagram 650 illustrating an example non-primary channel access (NPCA) STA in a scenario in which a STA switches to the O-Primary channel for reception. In the illustrated example, while contending for channel access on the M-Primary channel, the STA again detects an OBSS PPDU (e.g., PPDU 602) on the M-Primary channel. In response, the STA switches to the O-Primary channel and, after a switching delay, is ready to receive on the O-Primary channel. After receiving an RTS 604 on the O-Primary channel, the STA sends a CTS 606 and receives a PPDU 608 on the O-Primary channel. As illustrated, the STA may send an ACK 610 after receiving the PPDU.

### Overview of Bandwidth Signaling

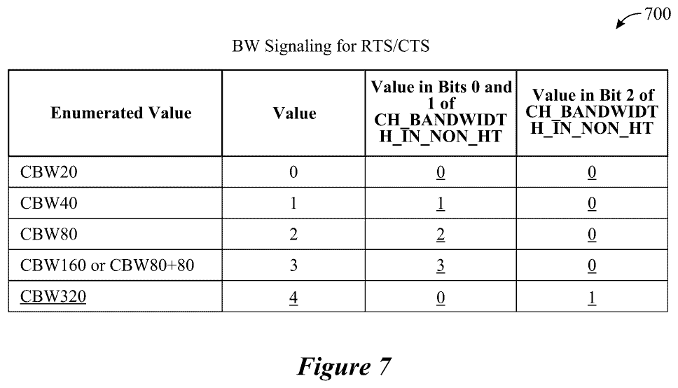

Certain 802.11 PPDUs carry an indication of the bandwidth occupied by the PPDU. As illustrated in table 700 of FIG. 7, RTS and CTS frames may carry the bandwidth in the SERVICE field if transmitted by a VHT/HE/EHT STA. If RTS/CTS is used for BW negotiation, RTS and its corresponding CTS can indicate different BW. In such cases, the PPDU occupies the BW indicated in the CTS frame. In some cases, if transmitted by an HT STA, the bandwidth may not be signaled.

In some cases, the PHY header of HE, EHT and UHR PPDUs may carry a bandwidth indication. For HE PPDU, this indication may be carried in the HE-SIG-A field. For EHT PPDU and UHR PPDU, this indication may be carried in the U-SIG field. In some cases, such signaling may be defined/mandated (e.g., for HE STAs and beyond) by certain wireless communication standards specifications.

### Overview of OBSS TSOPs

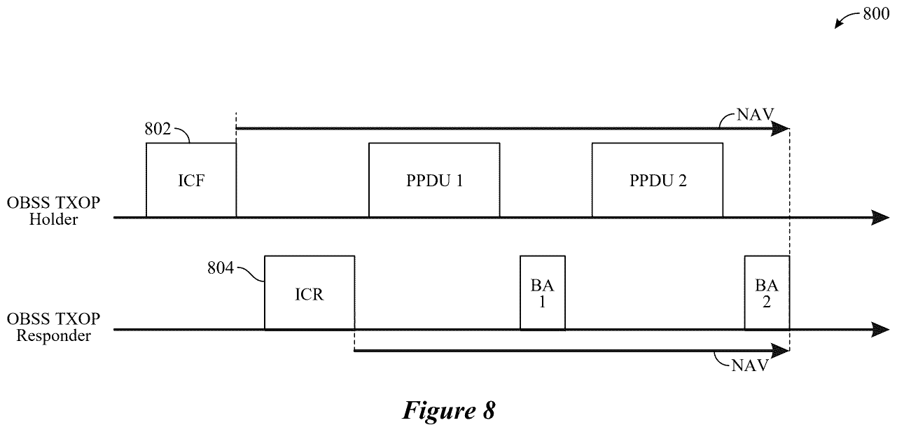

There are different types of OBSS TXOPs. A first type of TXOP 800 begins with a control frame exchange (e.g., RTS/CTS or MU-RTS/CTS), as illustrated in FIG. 8A. As illustrated for example, the OBSS TXOP holder may transmit an initial control frame (ICF) 802, and the OBSS TXOP responder may transmit, in response, an initial control response frame (ICR) 804. This may be described as a control frame exchange. After the control frame exchange, one or more PPDUs (labeled “PPDU 1” and “PPDU 2”) may be transmitted by the TXOP holder and respective block acknowledgments (BAs) (labeled “BA 1” and “BA 2”) may be transmitted by the TXOP responder, as shown. Aspects Related to Primary Channel Indication

An NPCA STA may contend for access to and transmit on the O-Primary channel if certain conditions are met. For example, an NPCA STA may contend and transmit on the O-Primary channel if the M-Primary channel is occupied by OBSS traffic and is, therefore, busy. An ultra-high reliability (UHR) device may be capable of monitoring additional 20 MHz primary channel(s) within the operating bandwidth. As described herein, the baseline primary channel may be referred to as Main Primary (M-Primary) channel and the additional primary channel may be referred to as an Opportunistic Primary (O-Primary) channel. If there are multiple O-Primary channels, monitoring of the O-Primary channels can be sequential or parallel. For sequential monitoring, an NPCA STA may be capable of monitoring only one primary channel at a time. By default, the NPCA STA monitors/contends on the M-Primary channel. When OBSS is detected on the M-primary channel, the STA switches (e.g., referred to herein as an NPCA switch) to O-Primary channel and monitors/contends on the O-Primary channel. For parallel monitoring, an NPCA STA may be capable of monitoring/contending on all the primary channels concurrently. Further, there may be cases where NPCA STA can detect PPDUs on multiple primary channels concurrently but can transmit/receive on only one primary channel at a time.

In NPCA, coordination may be lost between the AP and non-AP STA. The coordination loss may be a result of the AP being able to detect the OBSS on the M-Primary channel but the non-AP STA being unable to detect the OBSS on the M-Primary channel or when the non-AP STA can detect the OBSS on the M-Primary channel but the AP cannot. This lack of coordination may also occur if AP and non-AP STA latch to different OBSS PPDUs. As a result, scenarios may arise where the non-AP STA switches to the O-Primary channel but the AP remains on the M-Primary channel. In such scenarios, the AP may send a frame to the non-AP STA via the M-Primary channel, and the frame may occupy the entire BSS BW (e.g., occupy both the M-Primary and O-Primary channels). Because the non-AP STA has switched to the O-Primary channel, the non-AP STA may receive the frame via the O-Primary channel, which can lead to the non-AP STA concluding that the frame was sent via the O-Primary channel (e.g., when in fact, the frame was sent via the M-Primary channel). Depending on the type and function of the frame sent by the AP, the miscoordination can lead to some unintended consequences. For example, the AP may send duplicated RTS frames (e.g., non-high throughput (HT) duplicated RTS) via the M-Primary channel (including on the O-Primary channel) and the STA may receive the RTS on the O-Primary channel. As a result, the STA may respond on the O-Primary channel when the AP expects to receive the response on the M-Primary channel.

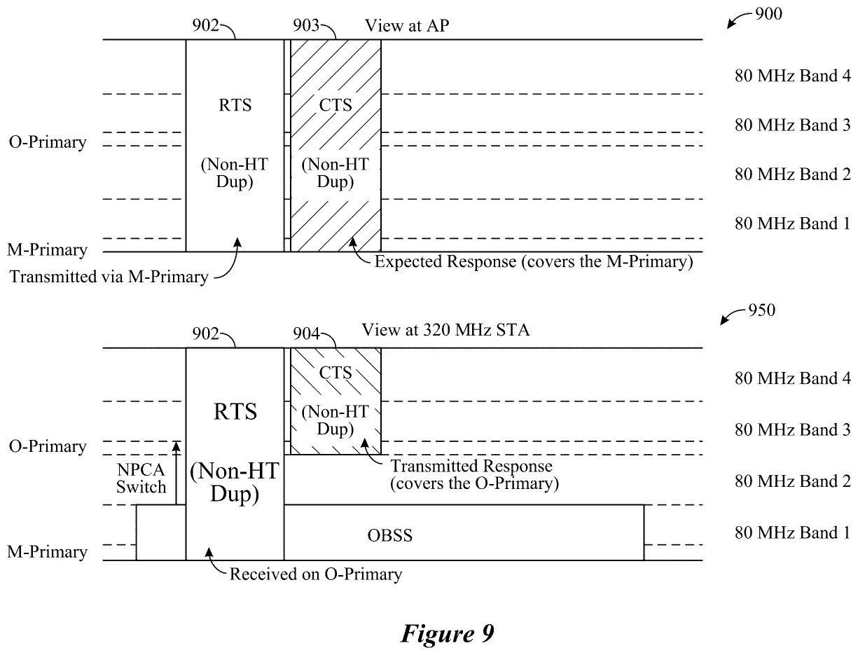

FIG. 9 illustrates RTS and CTS communications between an AP and a non-AP STA. Diagram 900 illustrates RTS and CTS communications from the perspective of the AP and diagram 950 illustrates the RTS and CTS communications from the perspective of the non-AP STA. As shown, the spectrum (e.g., BSS BW) for the RTS and CTS communications may include 320 MHz bandwidth including 80 MHz bands labeled “80 MHz band 1” (including a primary 20 MHz channel labeled as “M-Primary”), “80 MHz band 2”, “80 MHz band 3” (including an opportunistic primary 20 MHz channel labeled as “O-Primary”), and “80 MHz band 4.” The AP may transmit RTS 902 using frame duplication techniques such as non-HT duplication. That is, a duplicate RTS frame may be transmitted in each 20 MHz subband of the 320 MHz bandwidth including the M-Primary and the O-Primary channel. The RTS (e.g., duplicate RTS frames) may be transmitted across the entirety of the 320 MHz bandwidth (e.g., 20 MHz RTS frames may be duplicated across 320 MHz bandwidth). The AP may expect the non-AP STA to respond with a CTS 903 (e.g., duplicate CTS frames) that spans the 320 MHz bandwidth as shown in diagram 900. Alternatively, the AP may expect the non-AP STA to not respond if the M-Primary is Busy as seen at the non-AP STA. However, as shown in diagram 950, unlike the AP, the STA may have detected the OBSS signaling on the M-Primary channel and performed an NPCA switch from the M-Primary channel to the O-Primary channel. Thus, the non-AP STA receives the RTS frame via the O-Primary channel, resulting the non-AP STA responding with a CTS 904 (e.g., duplicate CTS frames) that spans the 160 MHz (e.g., 80 MHz band 3 and 80 MHz band 4) starting from the O-Primary channel instead of the entire BSS BW (320 MHz) including both the M-Primary channel and the O-Primary channel as expected by the AP.

The miscoordination described herein may also impact trigger frame and response communications. In some cases, due to the miscoordination, the AP may send a trigger frame via the M-Primary channel soliciting a response from the STA on a certain resource unit (RU) that is signaled with respect to the M-Primary channel, but the STA may receive the trigger frame on the O-Primary channel and infer the RU is with respect to the O-Primary channel. As a result, the STA may transmit a response on the wrong RU (e.g., a different RU than expected by the AP).

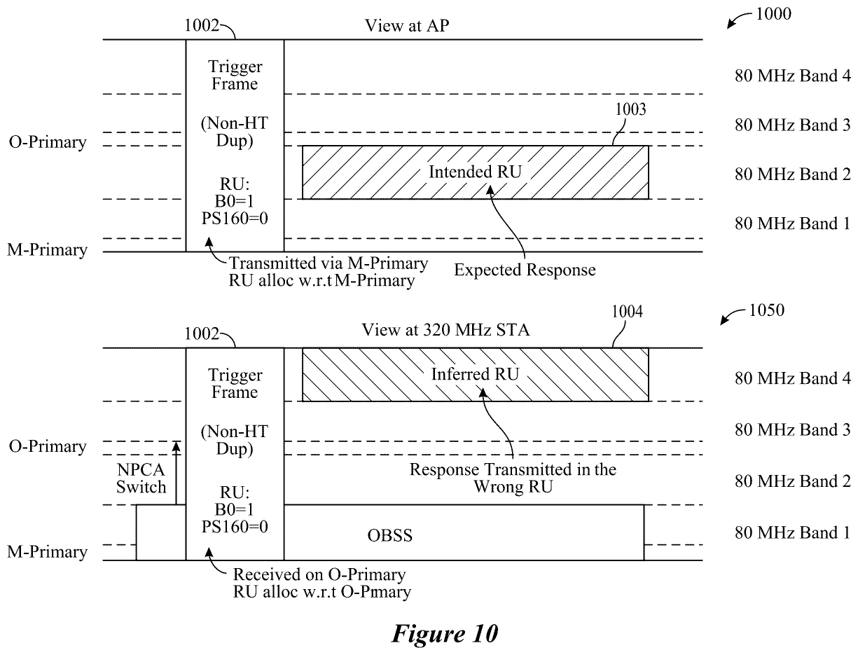

FIG. 10 illustrates a trigger frame and response communications between an AP and a non-AP STA. Diagram 1000 illustrates the trigger frame and response communications from the perspective of the AP and diagram 1050 illustrates the trigger frame and response communications from the perspective of the non-AP STA. As shown in diagram 1000, the AP may transmit a trigger frame 1002 using frame duplication (e.g., non-HT duplication) as described herein. The trigger frame may include a B0 parameter and a PS160 parameter. The PS160 parameter may indicate whether the response should be within the first 160 MHz (e.g., 80 MHz bands 1-2) or the second 160 MHz band (e.g., 80 MHz bands 3-4) with respect to the band in which the trigger frame was received. With the first or second 160 MHz, the B0 parameter may indicate whether the response should be within the first or second 80 MHz. For example, if PS160 indicates to use the second 160 MHz band, a B0 parameter of 1 may indicate to use the 80 MHz band 4. If the trigger frame is sent on the M-Primary channel (e.g., the entire 320 MHz including the M-Primary channel as shown) and the PS 160 parameter is 0 and the B0 parameter is 1, then the AP may expect to receive the response 1003 in the RU within the second 80 MHz (80 MHz band 2) after the M-Primary channel, similar to that shown in diagram 600. Thus, the frequency position at which the receiver transmits the response is determined based on the band in which the trigger frame is detected at the receiver.

As shown in diagram 1050, due to the miscoordination, the non-AP STA may receive the trigger frame 1002 (e.g., a trigger frame duplication) via the O-Primary channel. Thus, the non-AP STA may determine the frequency position (e.g., bands) in which to respond based on (e.g., with respect to) the O-Primary channel. Based on the PS160 parameter being 0 and B0 parameter being 1, the non-AP STA may transmit a response 1004 using 80 MHz band 4, as shown in diagram 1050 colliding with another non-AP STA that transmits on 80 MHz band 4, thereby degrading the performance of both STAs.

In some aspects, to avoid the impacts of the miscoordination described herein, the transmitted frame may indicate (e.g., using a “channel indication”) which primary channel (e.g., whether M-Primary channel or O-Primary channel) was used for transmission. Based on the indication, the frame communicates to the receiver whether the frame was sent via the M-Primary channel or the O-Primary channel. As used herein, transmitting a frame via a primary channel (e.g., M-Primary channel or O-Primary channel) implies that the AP or STA contended on that primary channel (e.g., including a countdown to 0) and thereafter transmitted the frame on the primary channel (e.g., performed successful contention-based access to transmit on the primary channel).

For ultra-high reliability (UHR), an NPCA STA may have only one O-Primary channel (e.g., in addition to one M-Primary channel). Thus, in this case, a single-bit indication may be used to indicate the primary channel via which the frame is transmitted. For example, a frame may include one bit, and when the bit is set to logic low (e.g., 0), the bit indicates that the frame was transmitted via the M-Primary channel. If the bit is set to logic high (e.g., 1), the bit indicates that the frame was transmitted via the O-Primary channel.

When there is more than one O-Primary channel, the indication can specify (e.g., with more than one bit) which primary channel was used to transmit the frame. A two-bit field may be used to signal the primary channel on which the frame is transmitted. For instance, if the field is set to 00, the frame may be transmitted via the M-Primary channel; if the field is set to 01, the frame may be transmitted via O-Primary channel #1 and so on. M-bits (e.g., M being a positive integer) may be used to signal 2^{M} primary channels. In some cases, the frame may carry a bitmap, and each bit in the bitmap may correspond to a unique primary channel. Using a bitmap, the number of bits in the bitmap may be equal to the number of M-Primary and O-Primary channels. The transmitter may set a bit in the bitmap to 1 if the PPDU carrying the frame was sent via the corresponding primary channel.

A STA that has enabled the NPCA mode may include the indication in certain frames transmitted via the O-Primary channel that meet a certain criteria. For example, the indication may be included when the frame is carried in a non-HT duplicate PPDU format. For example, the miscoordination scenarios described here may not apply for some other formats. That is, for some non-duplicated frame structures spanning the entire 320 MHz bandwidth, if the receiver does not receive the frame within the correct primary channel (e.g., M-Primary channel), the receiver cannot decode the frame.

In some cases, the channel indication may be included in all frames the transmitter transmits via the O-Primary channel. The recipient uses the explicit indication to determine what behavior the recipient is to follow. For instance, in the RTS/CTS case described herein, the recipient may not respond to the RTS on the O-Primary channel if the recipient received the RTS on the O-primary channel but the channel indication communicates that RTS was sent via the M-Primary channel (e.g., indicating a miscoordination). In the Trigger frame case, the recipient may use the channel indication (combined with the RU allocation information such as PS160 and B0 parameters) to determine which RU to transmit on (e.g., perform a translation of RU allocation based on the PS160 and B0 parameters and the indication of the primary channel via which the trigger frame was transmitted). In some cases, if the recipient receives the trigger frame on a different primary channel than is indicated by the channel indication of the frame, the recipient may not respond to the trigger frame. Which option to choose (e.g., calculating the RU allocation based on the indication or forgo responding) may be pre-defined in a technical standard, determined or provided by the AP (e.g., in one or more management frames), or provided by the STA as a capability.

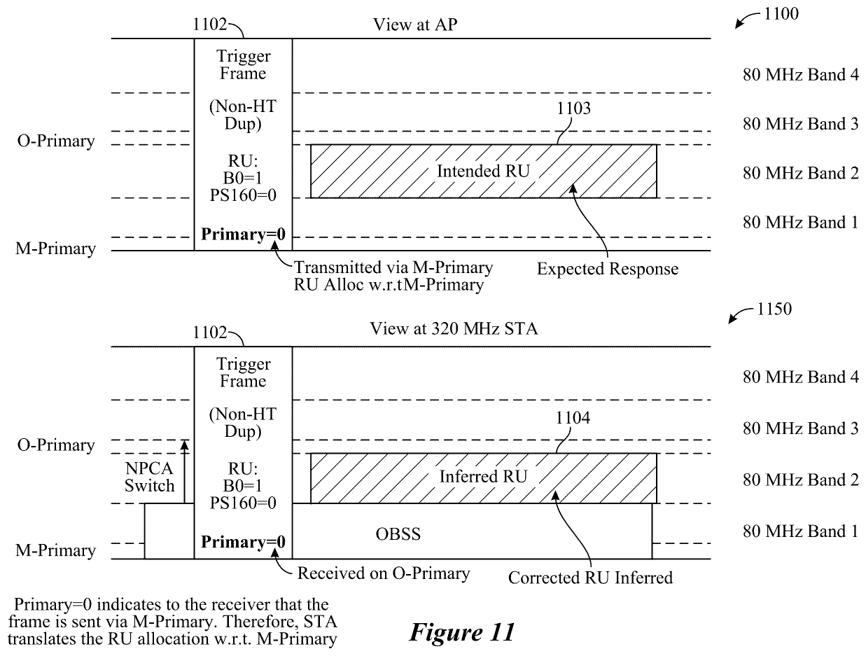

FIG. 11 illustrates trigger frame and response communications with a channel indication, in accordance with certain aspects of the present disclosure. Diagram 1100 illustrates the trigger frame and response communications from the perspective of the AP and diagram 1150 illustrates the trigger frame and response communications from the perspective of the non-AP STA. As shown, the trigger frame 1102 may include a PS160 parameter set to 0 and B0 parameter set to 1. The AP may transmit the trigger frame 1102 via the M-Primary channel. Thus, the AP may expect a response (e.g., expected response 1103) from the STA within the 80 MHz band 2 as shown in diagram 1100. However, as shown in diagram 1150, the STA may have detected the OBSS and performed an NPCA switch. Thus, the STA may receive the trigger frame 1102 via the O-primary channel. However, due to the channel indication within the trigger frame, the STA may still determine the RU for response (e.g., inferred response 1104) with respect to the M-primary channel. As shown, the primary channel indication may be set to 0, indicating that the frame was sent via the M-primary channel and the STA translates the RU allocation with respect to the M-primary channel so that the expected response 1103 and the inferred response 1104 have the same RU.

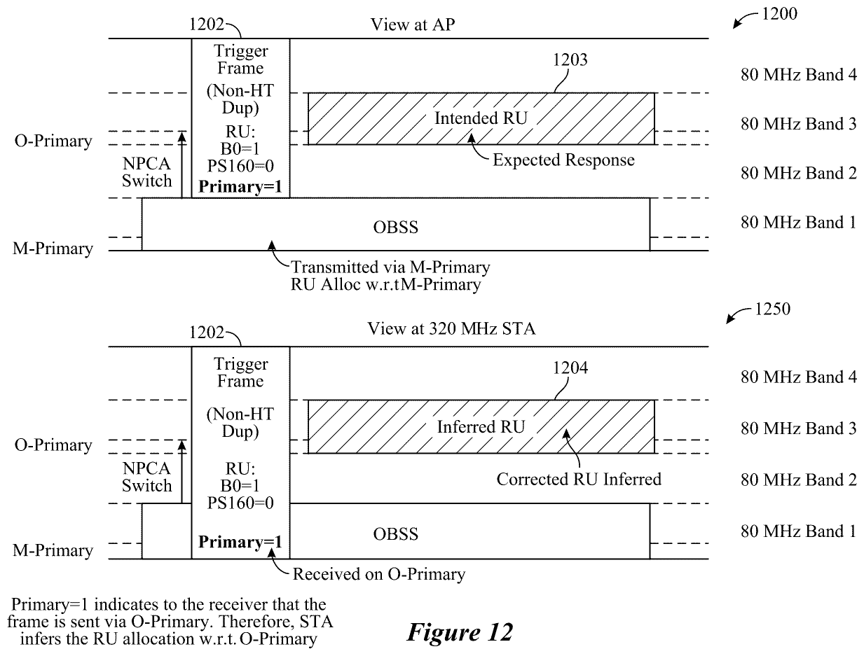

FIG. 12 illustrates trigger frame and response communications using a channel indication, in accordance with certain aspects of the present disclosure. Diagram 1200 illustrates the RTS and CTS communications from the perspective of the AP and diagram 1250 illustrates the RTS and CTS communications from the perspective of the non-AP STA. As shown in diagram 1200, the trigger frame 1202 may span the 80 MHz bands 2-4 and may include a channel indication of 1 indicating that the trigger frame was transmitted via the O-Primary channel. Thus, the AP intends for the RU to be allocated for the response (e.g., intended response 1203) on band 3 as shown in diagram 1200. As shown in diagram 1250, the STA may respond (e.g., inferred response 1204) on band 3 in accordance with the channel indication.

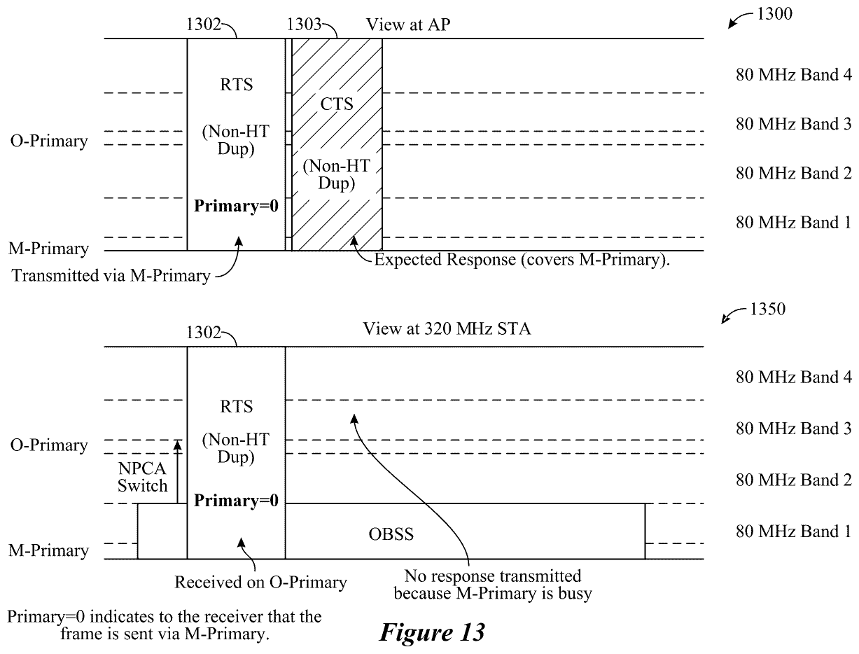

FIG. 13 illustrates RTS and CTS communications using a channel indication, in accordance with certain aspects of the present disclosure. Diagram 1300 illustrates the RTS and CTS communications from the perspective of the AP and diagram 1350 illustrates the RTS and CTS communications from the perspective of the non-AP STA. As shown in diagram 1300, the RTS 1302 may be transmitted via the M-Primary channel and the AP expects the CTS 1303 to cover the M-Primary channel as shown in diagram 1300. However, due to the NPCA switch of the STA as shown in diagram 1350, the STA may receive the RTS 1302 via the O-Primary channel. Based on the channel indication set to 0, the STA may determine that the RTS 1302 was transmitted via the M-Primary channel and, as a result, forgo responding with a CTS.

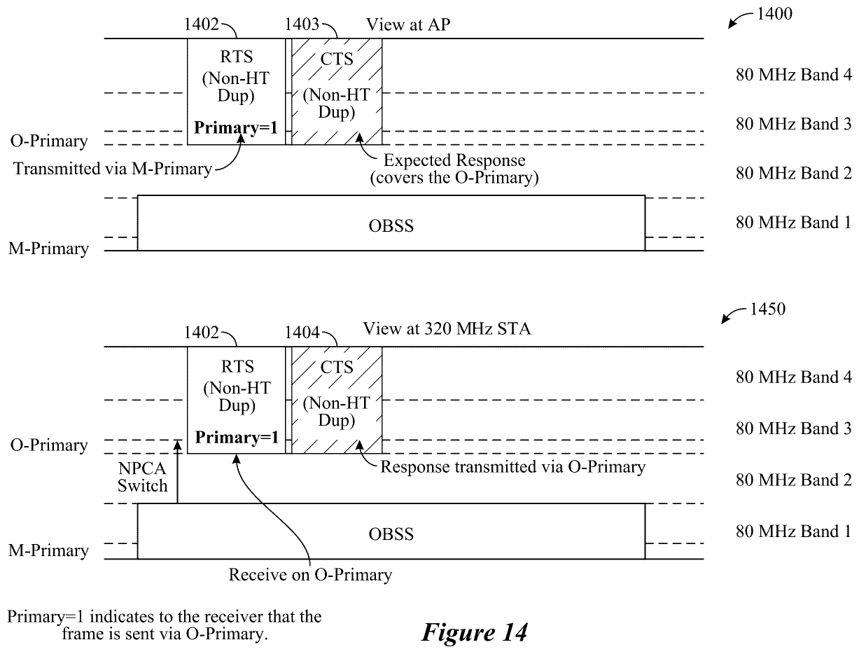

FIG. 14 illustrates RTS and CTS communications using a channel indication, in accordance with certain aspects of the present disclosure. Diagram 1400 illustrates the RTS and CTS communications from the perspective of the AP and diagram 1450 illustrates the RTS and CTS communications from the perspective of the non-AP STA. The RTS 1402 may be transmitted via the O-Primary channel with a channel indication of 1, indicating that the RTS was transmitted via the O-Primary channel. As shown in diagram 1450, the STA may receive the RTS 1402 on the O-Primary channel and may check the channel indication to determine whether the RTS 1402 was received via the proper channel (e.g., the same primary channel via which the RTS was transmitted). The STA may respond with a CTS via bands 3 and 4 that cover the O-primary channel as expected by the AP. Thus, the expected CTS 1403 and the transmitted CTS 1404 may be transmitted via the same primary channel.

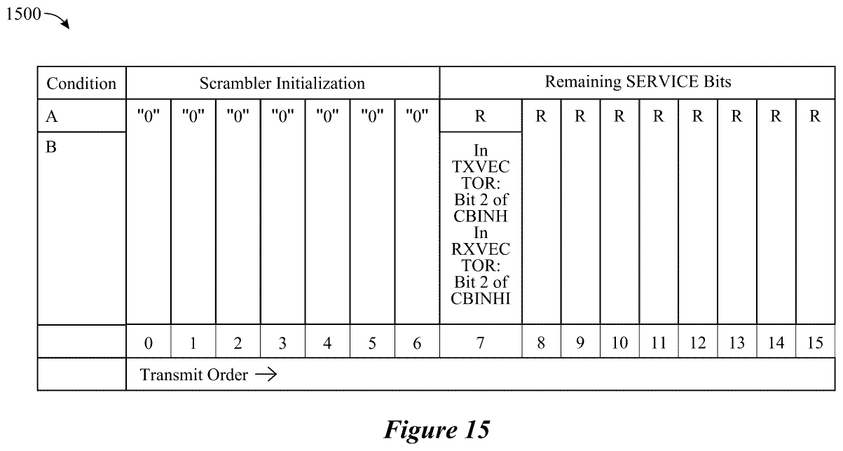

FIG. 15 illustrates a service field 1500 in which a channel indication may be included, in accordance with certain aspects of the present disclosure. In some aspects, the indication may be included in duplicate frames (e.g., non-HT duplicate frames including an RTS). For example, when a non-HT duplicate PPDU is transmitted and the frame is not a Trigger frame, the indication may be included in the SERVICE field 1500 of the PPDU. The indication may be a new bit among one of the Reserved SERVICE field bits (such as B8-B15 or B0-B4).

In some cases, the SERVICE field may indicate a BW associated with an RTS transmission. If the RTS/CTS exchange includes a BW indication, then the BW indicated in the SERVICE field can act as an implicit indication (e.g., the BW indication may be the channel indication described herein). For example, if the BW covers the M-Primary channel, the BW indicates to the receiver that the RTS is sent via the M-Primary channel. If not, then the BW indication indicates that the frame is sent via the O-Primary channel.

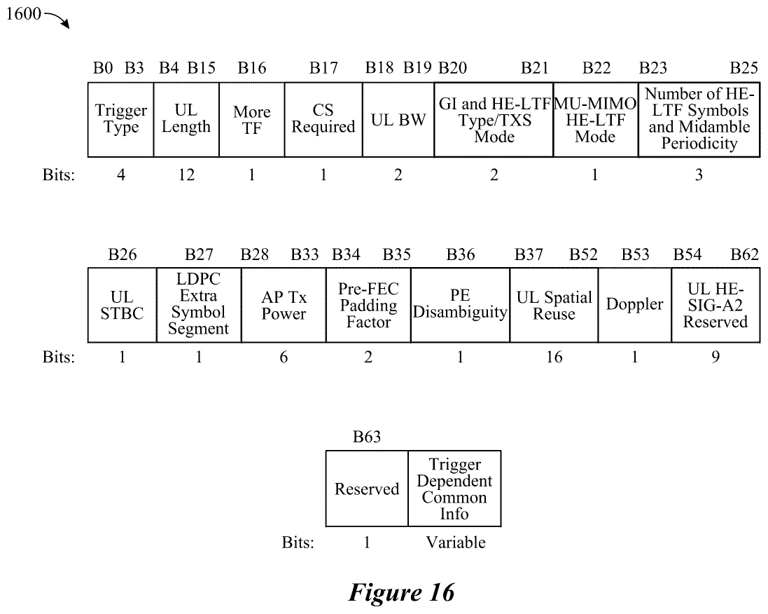

FIG. 16 illustrates a high-efficiency (HE) variant Common Information field 1600 in which a channel indication may be included, in accordance with certain aspects of the present disclosure. In some cases, the channel indication may be included in Trigger frames. If the Trigger frame is sent in a duplication PPDU format (e.g., non-HT duplicate PPDU format), then the channel indication may be included in the Trigger frame body. For example, one or more reserved bits in the Common Information field 1600 may be used to provide the channel indication. B63 may be used to indicate the channel indication if the Trigger frame has the HE variant Common Information field as shown.

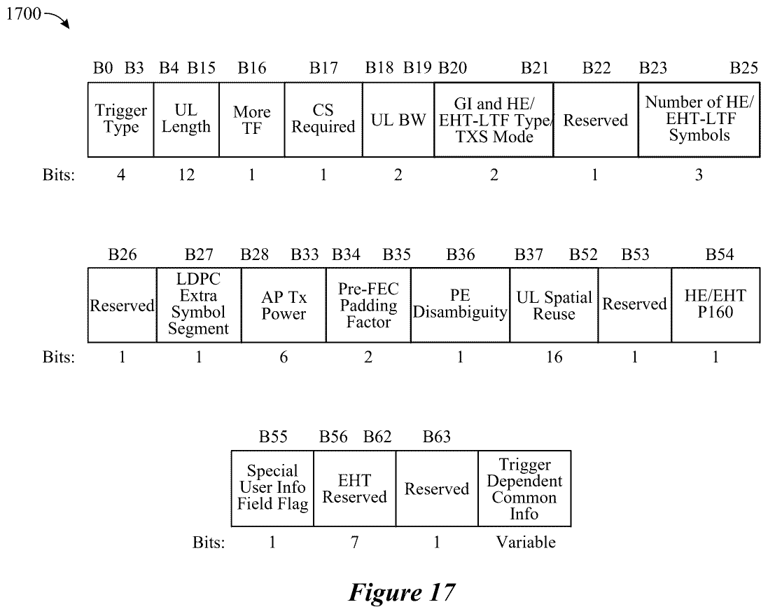

FIG. 17 illustrates an extremely high throughput (EHT) variant Common Info field 1700 in which a channel indication may be included, in accordance with certain aspects of the present disclosure. If the Trigger frame has the EHT variant Common Information field, then B22, B26, B53, and/or B63 may be used for the channel indication. If the Trigger frame is a multi-user (MU)-RTS Trigger frame, then other options may also be allowed. For example, any reserved bit may be used.

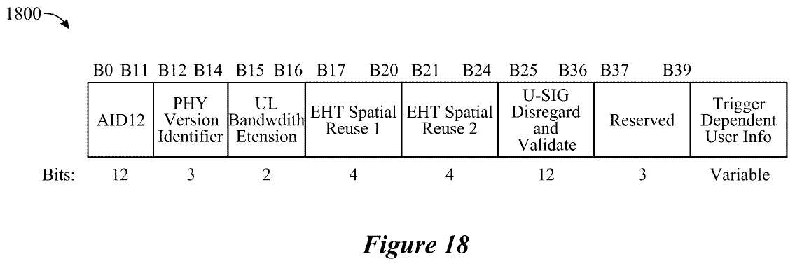

FIG. 18 illustrates a Special User information field 1800 of a Trigger frame in which a channel indication may be included, in accordance with certain aspects of the present disclosure. In some cases, the channel indication may be included in one or more bits between B37-B39.

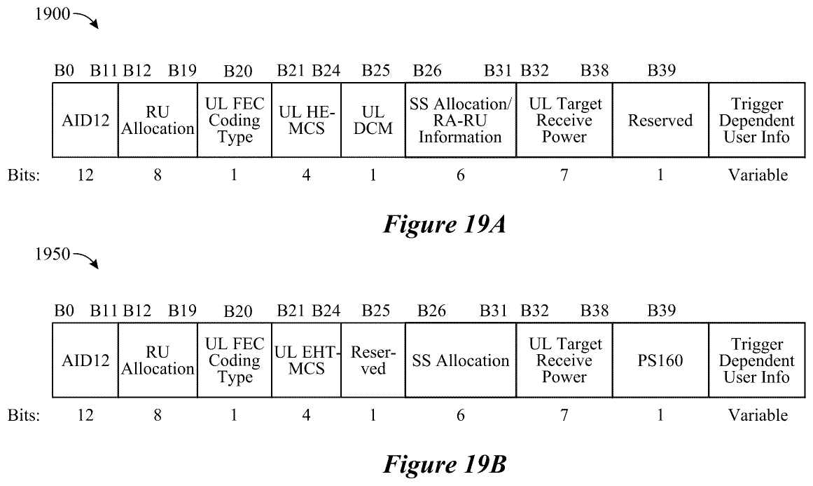

FIGS. 19A and 19B illustrate User Information fields 1900, 1950 in which a channel indication may be included, in accordance with certain aspects of the present disclosure. The channel indication may be included in B39 if the Trigger frame has an HE variant User Information field 1900 as shown in FIG. 16A or B25 if the Trigger frame has an EHT variant User Info field 1950 as shown in FIG. 16B. The benefit of signaling in the User Information field is that the User Information field may allow per-STA level control. In other words, the User Information field may be different for each STA. Thus, some STAs may follow the mapping with respect to the M-primary channel while other STAs that are parked on (e.g., contending on) the O-primary channel may perform the mapping with respect to the O-primary channel. Indication may be included in other frames. If the frame is sent in a UHR PPDU format (e.g., UHR duplicate PPDU), then the indication may be included in the physical layer (PHY) header (e.g., in the universal-signal (U-SIG) field or the UHR SIG field). The channel indication may also be included in the RTS/Trigger frames sent in UHR PPDU format.

Standards (e.g., IEEE standard) may specify certain conditions on frames transmitted via the O-Primary channel. The protocol may involve frames transmitted via the O-Primary channel being in a certain format (e.g., or certain formats may be prohibited on the O-primary channel). For example, a non-HT duplicate PPDU format may not be allowed when the frame is transmitted via the O-Primary channel, where other formats may be allowed. Only a UHR PPDU format may be allowed, and other formats may not be allowed in some cases. Thus, if the receiver observes a frame in a format that is not allowed to be transmitted via the O-Primary channel, then the receiver implies the frame to be transmitted via the M-Primary channel or vice-versa. In other words, the format of the frame transmission may serve as the channel indication described herein. Based on this inference, the receiver may adapt its behavior. For example, the receiver may not respond to the RTS frame, or translate the RU allocation to determine the actual RU via which to respond as described. These rules for the frames may only be for an initial Control frame or for all frames transmitted via the O-Primary channel.

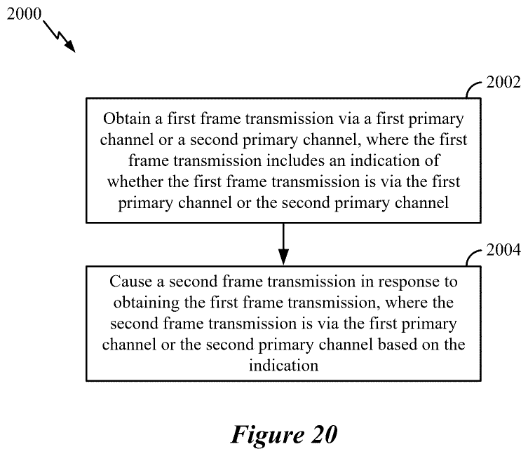

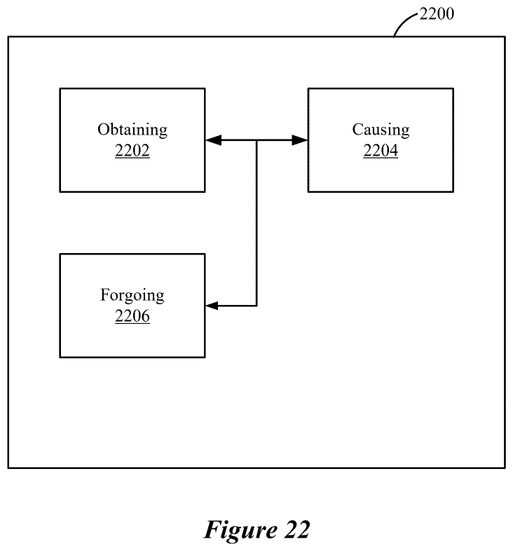

FIG. 20 shows a flowchart illustrating an example process 2000 performable by or at a wireless communication device that supports wireless communication. The operations of the process 2000 may be implemented by a wireless AP or its components as described herein, or a wireless STA or its components as described herein. For example, the process 2000 may be performed by a wireless communication device, such as the wireless communication device 2200 described with reference to FIG. 22, operating as or within a wireless AP or a wireless STA. In some examples, the process 2000 may be performed by a wireless AP such as one of the APs 102 described with reference to FIG. 1 or by a wireless STA such as one of the STAs 104 described with reference to FIG. 1.

In some examples, in block 2002, the wireless communication device may obtain a first frame transmission via a first primary channel or a second primary channel, where the first frame transmission includes an indication of whether the first frame transmission is via the first primary channel or the second primary channel.

At block 2004, the wireless communication device may cause a second frame transmission in response to obtaining the first frame transmission, where the second frame transmission is via the first primary channel or the second primary channel based on the indication.

In some aspects, the indication of whether the first frame transmission is via the first primary channel or the second primary channel comprises an indication of whether a transmitter performed a successful contention-based channel access on the first primary channel or the second primary channel to perform the first frame transmission. In some aspects, the indication comprises one or more bits included in the first frame transmission. In some aspects, the indication comprises a bitmap.

In some aspects, the first frame transmission is obtained via the second primary channel and the second frame transmission is performed based on the indication indicating that the first frame transmission is via the second primary channel.

In some aspects, the first frame transmission is performed via one of the first primary channel and the second primary channel. The first frame transmission may include a trigger frame including one or more resource unit (RU) allocation parameters indicating a channel for the second frame transmission with respect to the one of the first primary channel and the second primary channel. In some aspects, the second frame transmission is performed via a channel based on the RU allocation parameters and the indication.

In some aspects, the first frame transmission is obtained via the second primary channel, and wherein, to cause the second frame transmission. The processing system may be further configured to cause the wireless communication device to forgo the second frame transmission based on the indication indicating that the first frame transmission was transmitted via the first primary channel different than the second primary channel.

In some aspects, the first frame transmission includes the indication due to the first frame comprising a non-HT duplicate data transmission. In some aspects, the indication comprises an indication of a bandwidth associated with the first frame transmission. In some aspects, the second frame transmission is based on the bandwidth covering the first primary channel or the second primary channel. In some aspects, the indication comprises a format associated with the first frame transmission.

In some aspects, the first frame transmission includes a ready to send (RTS) frame transmission and the second frame transmission includes a clear to send (CTS) frame transmission. The first frame transmission may include a trigger frame. In some aspects, the first frame transmission comprises multiple duplicate frames transmitted via respective subbands. In some cases, the first primary channel includes a main primary channel and the second primary channel comprises an opportunistic primary channel.

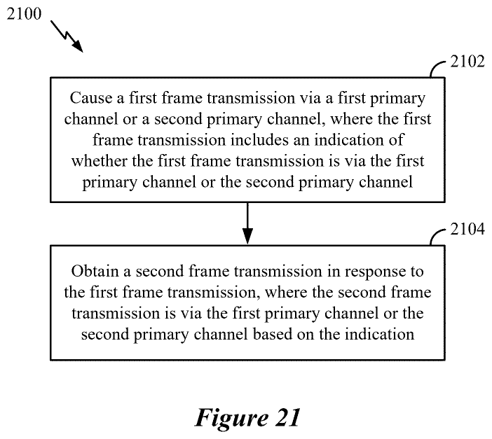

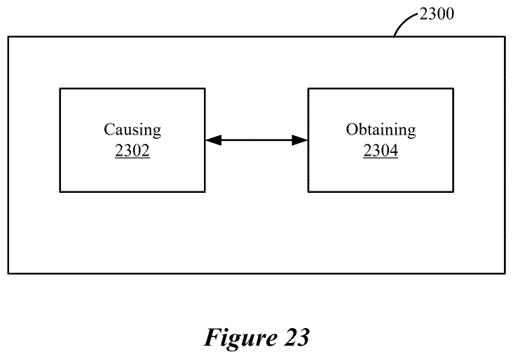

FIG. 21 shows a flowchart illustrating an example process 2100 performable by or at a wireless communication device that supports wireless communication. The operations of the process 2100 may be implemented by a wireless AP or its components as described herein, or a wireless STA or its components as described herein. For example, the process 2100 may be performed by a wireless communication device, such as the wireless communication device 2300 described with reference to FIG. 23, operating as or within a wireless AP or a wireless STA. In some examples, the process 2100 may be performed by a wireless AP such as one of the APs 102 described with reference to FIG. 1 or by a wireless STA such as one of the STAs 104 described with reference to FIG. 1.

In some examples, in block 2102, the communication device may cause a first frame transmission via a first primary channel or a second primary channel, where the first frame transmission includes an indication of whether the first frame transmission is via the first primary channel or the second primary channel.

At block 2104, the wireless communication device may obtain a second frame transmission in response to the first frame transmission, where the second frame transmission is via the first primary channel or the second primary channel based on the indication.

In some aspects, the indication of whether the first frame transmission is via the first primary channel or the second primary channel comprises an indication of whether the wireless communication device performed a successful contention-based channel access on the first primary channel or the second primary channel to perform the first frame transmission.

In some aspects, the indication comprises one or more bits included in the first frame transmission. In some aspects, the indication comprises a bitmap.

In some aspects, the first frame transmission is performed via one of the first primary channel and the second primary channel. The first frame transmission may include a trigger frame including one or more resource unit (RU) allocation parameters indicating a channel for the second frame transmission with respect to the one of the first primary channel and the second primary channel.

In some aspects, the first frame transmission includes the indication due to the first frame comprising a non-HT duplicate data transmission.

The indication comprises an indication of a bandwidth associated with the first frame transmission. The indication may include a format associated with the first frame transmission.

The first frame transmission may include a ready to send (RTS) frame transmission and the second frame transmission includes a clear to send (CTS) frame transmission. In some aspects, the first frame transmission comprises a trigger frame. The first frame transmission comprises multiple duplicate frames transmitted via respective subbands. The first primary channel may include a main primary channel and the second primary channel comprises an opportunistic primary channel.

FIG. 22 shows a block diagram of an example wireless communication device 2200 that supports wireless communication. In some examples, the wireless communication device 2200 is configured to perform the process 2000 described with reference to FIG. 20. The wireless communication device 2200 may include one or more chips, SoCs, chipsets, packages, components or devices that individually or collectively constitute or include a processing system. The processing system may interface with other components of the wireless communication device 2200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2200 may transmit the information output from the chip. In such an example, the second interface may refer to an interface between the processing system of the chip and a reception component, such that the device 2200 may receive information that is passed to the processing system. In some such examples, the first interface also may obtain information, such as from the transmission component, and the second interface also may output information, such as to the reception component.

The processing system of the wireless communication device 2200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2200 can be configurable or configured for use in an AP, such as the AP 102 described with reference to FIG. 1. In some other examples, the wireless communication device 2200 can be an AP that includes such a processing system and other components including multiple antennas. The wireless communication device 2200 is capable of transmitting and receiving wireless communications in the form of, for example, wireless packets. For example, the wireless communication device 2200 can be configurable or configured to transmit and receive packets in the form of physical layer PPDUs and MPDUs conforming to one or more of the IEEE 802.11 family of wireless communication protocol standards. In some other examples, the wireless communication device 2200 can be configurable or configured to transmit and receive signals and communications conforming to one or more 3GPP specifications including those for 5G NR or 6G. In some examples, the wireless communication device 2200 also includes or can be coupled with one or more application processors which may be further coupled with one or more other memories. In some examples, the wireless communication device 2200 further includes at least one external network interface coupled with the processing system that enables communication with a core network or backhaul network that enables the wireless communication device 2200 to gain access to external networks including the Internet.

The wireless communication device 2200 includes an obtaining component 2202, a causing component 2204, and a forgoing component 2206. Portions of one or more of the components 2202, 2204, and 2206 may be implemented at least in part in hardware or firmware. For example, the obtaining component 2202 may be implemented at least in part by a processor or a modem. In some examples, portions of one or more of the components 2202, 2204, and 2206 may be implemented at least in part by a processor and software in the form of processor-executable code stored in a memory.

The obtaining component 2202 is configurable or configured to a first frame transmission via a first primary channel or a second primary channel, wherein the first frame transmission includes an indication of whether the first frame transmission is via the first primary channel or the second primary channel.

The causing component 2204 is configurable or configured to cause a second frame transmission in response to obtaining the first frame transmission, wherein the second frame transmission is via the first primary channel or the second primary channel based on the indication.

The forgoing component 2206 is configurable or configured to forgo the second frame transmission based on the indication indicating that the first frame transmission was transmitted via the first primary channel different than the second primary channel.

FIG. 23 shows a block diagram of an example wireless communication device 2300 that supports wireless communication. In some examples, the wireless communication device 2300 is configured to perform the process 2100 described with reference to FIG. 21. The wireless communication device 2300 may include one or more chips, SoCs, chipsets, packages, components or devices that individually or collectively constitute or include a processing system. The processing system may interface with other components of the wireless communication device 2300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2300 may transmit the information output from the chip. In such an example, the second interface may refer to an interface between the processing system of the chip and a reception component, such that the device 2300 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2300 can be configurable or configured for use in a STA, such as the STA 104 described with reference to FIG. 1. In some other examples, the wireless communication device 2300 can be a STA that includes such a processing system and other components including multiple antennas. The wireless communication device 2300 is capable of transmitting and receiving wireless communications in the form of, for example, wireless packets. For example, the wireless communication device 2300 can be configurable or configured to transmit and receive packets in the form of physical layer PPDUs and MPDUs conforming to one or more of the IEEE 802.11 family of wireless communication protocol standards. In some other examples, the wireless communication device 2300 can be configurable or configured to transmit and receive signals and communications conforming to one or more 3GPP specifications including those for 5G NR or 6G. In some examples, the wireless communication device 2300 also includes or can be coupled with one or more application processors which may be further coupled with one or more other memories. In some examples, the wireless communication device 2300 further includes a user interface (UI) (such as a touchscreen or keypad) and a display, which may be integrated with the UI to form a touchscreen display that is coupled with the processing system. In some examples, the wireless communication device 2300 may further include one or more sensors such as, for example, one or more inertial sensors, accelerometers, temperature sensors, pressure sensors, or altitude sensors, that are coupled with the processing system.

The wireless communication device 2300 includes a causing component 2302 and an obtaining component 2304. Portions of one or more of the components 2302 and 2304 may be implemented at least in part in hardware or firmware. For example, the causing component 2302 may be implemented at least in part by a processor or a modem. In some examples, portions of one or more of the components 2302 and 2304 may be implemented at least in part by a processor and software in the form of processor-executable code stored in the memory.

The causing component 2302 is configurable or configured to cause a first frame transmission via a first primary channel or a second primary channel, wherein the first frame transmission includes an indication of whether the first frame transmission is via the first primary channel or the second primary channel.

The obtaining component 2304 is configurable or configured to obtain a second frame transmission in response to the first frame transmission, wherein the second frame transmission is via the first primary channel or the second primary channel based on the indication.

Implementation examples are described in the following numbered clauses:

Clause 1: A wireless communication device, including: a processing system that includes one or more processors and one or more memories coupled with the one or more processors, the processing system configured to cause the wireless communication device to: obtain a first frame transmission via a first primary channel or a second primary channel, where the first frame transmission includes an indication of whether the first frame transmission is via the first primary channel or the second primary channel; and cause a second frame transmission in response to obtaining the first frame transmission, where the second frame transmission is via the first primary channel or the second primary channel based on the indication.

Clause 2: The wireless communication device of Clause 1, where the indication of whether the first frame transmission is via the first primary channel or the second primary channel includes an indication of whether a transmitter performed a successful contention-based channel access on the first primary channel or the second primary channel to perform the first frame transmission.

Clause 3: The wireless communication device of Clause 1 or 2, where the indication includes one or more bits included in the first frame transmission.

Clause 4: The wireless communication device according to any of Clauses 1-3, where the indication includes a bitmap.

Clause 5: The wireless communication device according to any of Clauses 1-4, where: the first frame transmission is obtained via the second primary channel; and the second frame transmission is performed based on the indication indicating that the first frame transmission is via the second primary channel.

Clause 6: The wireless communication device according to any of Clauses 1-5, where: the first frame transmission is performed via one of the first primary channel and the second primary channel; and the first frame transmission includes a trigger frame including one or more resource unit (RU) allocation parameters indicating a channel for the second frame transmission with respect to the one of the first primary channel and the second primary channel.

Clause 7: The wireless communication device of Clause 6, where the second frame transmission is performed via a channel based on the RU allocation parameters and the indication.

Clause 8: The wireless communication device according to any of Clauses 1-7, where the first frame transmission is obtained via the second primary channel, and where, to cause the second frame transmission, the processing system is further configured to cause the wireless communication device to forgo the second frame transmission based on the indication indicating that the first frame transmission was transmitted via the first primary channel different than the second primary channel.

Clause 9: The wireless communication device according to any of Clauses 1-8, where the first frame transmission includes the indication due to the first frame including a non-HT duplicate data transmission.

Clause 10: The wireless communication device according to any of Clauses 1-9, where the indication includes an indication of a bandwidth associated with the first frame transmission.

Clause 11: The wireless communication device of Clause 10, where the second frame transmission is based on the bandwidth covering the first primary channel or the second primary channel.

Clause 12: The wireless communication device according to any of Clauses 1-11, where the indication includes a format associated with the first frame transmission.

Clause 13: The wireless communication device according to any of Clauses 1-12, where: the first frame transmission includes a ready to send (RTS) frame transmission; and the second frame transmission includes a clear to send (CTS) frame transmission.

Clause 14: The wireless communication device according to any of Clauses 1-13, where the first frame transmission includes a trigger frame.

Clause 15: The wireless communication device according to any of Clauses 1-14, where the first frame transmission includes multiple duplicate frames transmitted via respective subbands.

Clause 16: The wireless communication device according to any of Clauses 1-15, where: the first primary channel includes a main primary channel; and the second primary channel includes an opportunistic primary channel.

Clause 17: A wireless communication device, including: a processing system that includes one or more processors and one or more memories coupled with the one or more processors, the processing system configured to cause the wireless communication device to: cause a first frame transmission via a first primary channel or a second primary channel, where the first frame transmission includes an indication of whether the first frame transmission is via the first primary channel or the second primary channel; and obtain a second frame transmission in response to the first frame transmission, where the second frame transmission is via the first primary channel or the second primary channel based on the indication.

Clause 18: The wireless communication device of Clause 17, where the indication of whether the first frame transmission is via the first primary channel or the second primary channel includes an indication of whether the wireless communication device performed a successful contention-based channel access on the first primary channel or the second primary channel to perform the first frame transmission.

Clause 19: The wireless communication device of Clause 17 or 18, where the indication includes one or more bits included in the first frame transmission.

Clause 20: The wireless communication device according to any of Clauses 17-19, where the indication includes a bitmap.

Clause 21: The wireless communication device according to any of Clauses 17-20, where: the first frame transmission is performed via one of the first primary channel and the second primary channel; and the first frame transmission includes a trigger frame including one or more resource unit (RU) allocation parameters indicating a channel for the second frame transmission with respect to the one of the first primary channel and the second primary channel.

Clause 22: The wireless communication device according to any of Clauses 17-21, where the first frame transmission includes the indication due to the first frame including a non-HT duplicate data transmission.

Clause 23: The wireless communication device according to any of Clauses 17-22, where the indication includes an indication of a bandwidth associated with the first frame transmission.

Clause 24: The wireless communication device according to any of Clauses 17-23, where the indication includes a format associated with the first frame transmission.

Clause 25: The wireless communication device according to any of Clauses 17-24, where: the first frame transmission includes a ready to send (RTS) frame transmission; and the second frame transmission includes a clear to send (CTS) frame transmission.

Clause 26: The wireless communication device according to any of Clauses 17-25, where the first frame transmission includes a trigger frame.

Clause 27: The wireless communication device according to any of Clauses 17-26, where the first frame transmission includes multiple duplicate frames transmitted via respective subbands.

Clause 28: The wireless communication device according to any of Clauses 17-27, where: the first primary channel includes a main primary channel; and the second primary channel includes an opportunistic primary channel.

Clause 29: A method for wireless communication by a wireless communication device, comprising: obtaining a first frame transmission via a first primary channel or a second primary channel, wherein the first frame transmission includes an indication of whether the first frame transmission is via the first primary channel or the second primary channel; and causing a second frame transmission in response to obtaining the first frame transmission, wherein the second frame transmission is via the first primary channel or the second primary channel based on the indication.

Clause 30. A method for wireless communication by a wireless communication device, comprising: causing a first frame transmission via a first primary channel or a second primary channel, wherein the first frame transmission includes an indication of whether the first frame transmission is via the first primary channel or the second primary channel; and obtaining a second frame transmission in response to the first frame transmission, wherein the second frame transmission is via the first primary channel or the second primary channel based on the indication.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a”and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes one or more processors and one or more memories coupled with the one or more processors, the processing system configured to cause the wireless communication device to:
obtain a first frame transmission via a first primary channel or a second primary channel, wherein the first frame transmission includes an indication of whether the first frame transmission is via the first primary channel or the second primary channel; and
cause a second frame transmission in response to obtaining the first frame transmission, wherein the second frame transmission is via the first primary channel or the second primary channel based on the indication.

2. The wireless communication device of claim 1, wherein the indication of whether the first frame transmission is via the first primary channel or the second primary channel comprises an indication of whether a transmitter performed a successful contention-based channel access on the first primary channel or the second primary channel to perform the first frame transmission.

3. The wireless communication device of claim 1, wherein the indication comprises one or more bits included in the first frame transmission.

4. The wireless communication device of claim 1, wherein the indication comprises a bitmap.

5. The wireless communication device of claim 1, wherein:
the first frame transmission is obtained via the second primary channel; and
the second frame transmission is performed based on the indication indicating that the first frame transmission is via the second primary channel.

6. The wireless communication device of claim 1, wherein:
the first frame transmission is performed via one of the first primary channel and the second primary channel; and
the first frame transmission comprises a trigger frame including one or more resource unit (RU) allocation parameters indicating a channel for the second frame transmission with respect to the one of the first primary channel and the second primary channel.

7. The wireless communication device of claim 6, wherein the second frame transmission is performed via a channel based on the RU allocation parameters and the indication.

8. The wireless communication device of claim 1, wherein the first frame transmission is obtained via the second primary channel, and wherein, to cause the second frame transmission, the processing system is further configured to cause the wireless communication device to forgo the second frame transmission based on the indication indicating that the first frame transmission was transmitted via the first primary channel different than the second primary channel.

9. The wireless communication device of claim 1, wherein the first frame transmission includes the indication due to the first frame transmission comprising a non-HT duplicate data transmission.

10. The wireless communication device of claim 1, wherein the indication comprises an indication of a bandwidth associated with the first frame transmission.

11. The wireless communication device of claim 10, wherein the second frame transmission is based on the bandwidth covering the first primary channel or the second primary channel.

12. The wireless communication device of claim 1, wherein the indication comprises a format associated with the first frame transmission.

13. The wireless communication device of claim 1, wherein:
the first frame transmission includes a ready to send (RTS) frame transmission; and
the second frame transmission includes a clear to send (CTS) frame transmission.

14. The wireless communication device of claim 1, wherein the first frame transmission comprises a trigger frame.

15. The wireless communication device of claim 1, wherein the first frame transmission comprises multiple duplicate frames transmitted via respective subbands.

16. The wireless communication device of claim 1, wherein:
the first primary channel comprises a main primary channel; and
the second primary channel comprises an opportunistic primary channel.

17. A wireless communication device, comprising:
a processing system that includes one or more processors and one or more memories coupled with the one or more processors, the processing system configured to cause the wireless communication device to:
cause a first frame transmission via a first primary channel or a second primary channel, wherein the first frame transmission includes an indication of whether the first frame transmission is via the first primary channel or the second primary channel; and
obtain a second frame transmission in response to the first frame transmission, wherein the second frame transmission is via the first primary channel or the second primary channel based on the indication.

18. The wireless communication device of claim 17, wherein the indication of whether the first frame transmission is via the first primary channel or the second primary channel comprises an indication of whether the wireless communication device performed a successful contention-based channel access on the first primary channel or the second primary channel to perform the first frame transmission.

19. The wireless communication device of claim 17, wherein the indication comprises one or more bits included in the first frame transmission.

20. The wireless communication device of claim 17, wherein the indication comprises a bitmap.

21. The wireless communication device of claim 17, wherein:
the first frame transmission is performed via one of the first primary channel and the second primary channel; and
the first frame transmission comprises a trigger frame including one or more resource unit (RU) allocation parameters indicating a channel for the second frame transmission with respect to the one of the first primary channel and the second primary channel.

22. The wireless communication device of claim 17, wherein the first frame transmission includes the indication due to the first frame transmission comprising a non-HT duplicate data transmission.

23. The wireless communication device of claim 17, wherein the indication comprises an indication of a bandwidth associated with the first frame transmission.

24. The wireless communication device of claim 17, wherein the indication comprises a format associated with the first frame transmission.

25. The wireless communication device of claim 17, wherein:
the first frame transmission includes a ready to send (RTS) frame transmission;
and the second frame transmission includes a clear to send (CTS) frame transmission.

26. The wireless communication device of claim 17, wherein the first frame transmission comprises a trigger frame.

27. The wireless communication device of claim 17, wherein the first frame transmission comprises multiple duplicate frames transmitted via respective subbands.

28. The wireless communication device of claim 17, wherein:
the first primary channel comprises a main primary channel; and
the second primary channel comprises an opportunistic primary channel.

29. A method for wireless communication by a wireless communication device, comprising:
obtaining a first frame transmission via a first primary channel or a second primary channel, wherein the first frame transmission includes an indication of whether the first frame transmission is via the first primary channel or the second primary channel; and
causing a second frame transmission in response to obtaining the first frame transmission, wherein the second frame transmission is via the first primary channel or the second primary channel based on the indication.

30. A method for wireless communication by a wireless communication device, comprising:
causing a first frame transmission via a first primary channel or a second primary channel, wherein the first frame transmission includes an indication of whether the first frame transmission is via the first primary channel or the second primary channel; and
obtaining a second frame transmission in response to the first frame transmission, wherein the second frame transmission is via the first primary channel or the second primary channel based on the indication.
